(19) United States
(12) Patent Application Publication
(10) Pub. No.: US 2017/0328116 A1
(43) Pub. Date: Nov. 16, 2017

(54) METHOD FOR CONTROLLING A MOTORIZED CLOSURE ELEMENT ARRANGEMENT OF A MOTOR VEHICLE

(71) Applicant: Brose Fahrzeugteile GmbH & Co. KG, Bamberg, Bamberg (DE)

(72) Inventor: Bernd Herthan, Michelau (DE)

(21) Appl. No.: 15/581,821

(22) Filed: Apr. 28, 2017

(30) Foreign Application Priority Data
May 11, 2016 (DE) 10 2016 108 702.5

(51) Int. Cl. E05F 15/73

(52) U.S. Cl. CPC E05F 15/73; E05F 2015/767; E05Y 2900/546

(57) ABSTRACT

The disclosure relates to a method for activating a motorized closure element assembly of a vehicle, wherein the closure element assembly comprises a closure element, a control assembly, and a sensor assembly. The measured values of the sensor assembly are monitored by the control assembly to determine whether a triggering operating situation, defined by an operating-situation condition, is present, and an activation of the closure element assembly is triggered by the control assembly upon detection of the triggering operating situation. It is proposed that an operating-situation condition of the triggering operating situation is defined by the orientation of at least one body part of the operator about the vertical axis lying within a predetermined permitted orientation range, and whether the orientation of the body part lies within the permitted orientation range is detected by the sensor assembly and, depending thereon, the activation of the closure element assembly is triggered.

### CLAIM OF PRIORITY

This application claims the benefit of German Patent application No. DE 10 2016 108 702.5 filed on May 11, 2016, the disclosure of which is incorporated herein by reference.

### FIELD OF THE TECHNOLOGY

The disclosure relates to a method for activating a motorized closure element assembly of a motor vehicle and to a control system for a motorized closure element assembly.

### BACKGROUND

Motorized closure element assemblies have become largely commonplace in recent years within the scope of increasing comfort with respect to motor vehicles. The closure elements of such closure element assemblies can be, for example, doors, in particular side doors, gates and hoods, in particular tailgates, trunk hoods, engine hoods, cargo-area floors, or the like, of a motor vehicle. In this respect, the term “closure element” is considered to be broadly interpreted in this case. A drive assembly is often assigned to the closure element of the closure element assembly, by which the closure element can be opened and closed with or by a motor. In order to configure the triggering of the activation of the closure element assembly to be particularly comfortable for the operator, the detection of a triggering operating situation is increasingly carried out instead by sensors. One example thereof is provided by DE 10 2014 101 661 A1 which relates to a method for activating a motorized tailgate assembly of a motor vehicle.

The aforementioned method relates to the detection of a predetermined foot movement of the operator. Said method makes it possible to reduce erroneous detections by way of detecting not only the moving leg of the operator, but also the stationary leg of the operator. Due to the detection of two body parts, a particularly high reliability of detection overall results.

In one further known method for activating a motorized tailgate assembly (DE 10 2013 010 994 A1), the reliability of detection is increased by detecting a movement of a body part of the upper body of the operator.

The known methods have proven successful in practical application especially for the case in which a predetermined operator movement, in particular an operator gesture, is utilized for triggering the activation of the particular closure element assembly. A challenge results when the operator movements intended for triggering the activation are not as pronounced as a foot movement or when no operator movements at all are provided for triggering the activation. In the latter case in particular, a high reliability of detection can be achieved only with a great deal of complexity in the case of the known methods.

### SUMMARY

A problem addressed by the disclosure is that of providing a method for activating a motorized closure element assembly of a motor vehicle, with which the reliability of detection in terms of detecting an operating situation is increased without a great deal of complexity.

The aforementioned problem is solved in the case of a method according to various embodiments disclosed herein.

Various embodiments are based on the fundamental finding that incorporating the orientation of at least one body part of the operator into the operating-situation monitoring can result in a particularly high reliability of detection. For example, an activation of the closure element assembly is usually not desirable when the upper body of the operator is facing away from the closure element. According to the solution according to the disclosure, this can be detected with sensors, thereby ruling out an activation of the closure element assembly in the event that an upper body of the operator is facing away therefrom in the aforementioned way.

Specifically, it is very generally proposed that an operating-situation condition of the triggering operating situation is defined by the orientation of at least one body part of the operator about the vertical axis lying within a predetermined permitted orientation range. The orientation of the body part is therefore the swivel position of the body part about the vertical axis. On the basis of this swivel position, it is determined whether the relevant body part is facing the closure element or is facing away from the closure element.

According to the disclosure, it is further provided that whether the orientation of the at least one body part of the operator about the vertical axis lies in the permitted orientation range is detected with the sensor assembly. The activation of the closure element assembly is carried out depending on the result of this detection.

With the proposed solution, a large portion of erroneous triggerings of the closure element assembly can be avoided since the orientation of at least one body part of the operator provides a starting point for determining whether the activation of the closure element assembly is desired or not at the particular moment.

In various embodiments, an operating-situation condition of the triggering operating situation is defined by the front side of at least one body part of the operator facing the closure element. The body part can be, for example, the upper body of the operator, the head of the operator, or an eye of the operator.

In some embodiments, the reliability of detection can be further increased by way of the triggering operating situation—the detection of which results in an activation of the closure element assembly—including the orientation of two or more body parts of the operator. For example, it can be advantageous that the triggering operating situation includes not only a predetermined orientation of the upper body, but also a predetermined orientation of the head of the operator.

According to a further embodiment, a control system for a motorized closure element assembly of a motor vehicle is disclosed, which is used, in particular, for carrying out the aforementioned method according to the disclosure.

According to one further teaching, it is essential that the control system comprises a control assembly and a sensor assembly which interact with one another in order to implement the method according to the disclosure. In this respect, reference is made to all comments related to the method according to the disclosure.

An embodiment provides a method for activating a motorized closure element assembly of a motor vehicle, wherein the closure element assembly comprises a closure element, a control assembly, and a sensor assembly, wherein the measured sensor values of the sensor assembly are monitored by or with the control assembly to determine whether a triggering operating situation, which is defined by at least one operating-situation condition, is present, and wherein an activation of the closure element assembly is triggered by or with the control assembly upon detection of the triggering operating situation, wherein an operating-situation condition of the triggering operating situation is defined by the orientation of at least one body part of the operator about the vertical axis lying within a predetermined permitted orientation range, and whether the orientation of the at least one body part of the operator about the vertical axis lies within the permitted orientation range is detected by or with the sensor assembly and, depending thereon, the activation of the closure element assembly is triggered.

In some embodiments, an operating-situation condition of the triggering operating situation is defined by the front side of at least one body part of the operator facing the closure element by way of the front side of the relevant body part of the operator deviating from its orientation with respect to a predetermined reference point on the closure element only within the permitted orientation range.

In some embodiments, an operating-situation condition of the triggering operating situation is defined by the front side of the upper body of the operator facing the closure element within the scope of the permitted orientation range.

In some embodiments, an operating-situation condition of the triggering operating situation is defined by the front side of the head of the operator facing the closure element within the scope of the permitted orientation range.

In some embodiments, an operating-situation condition of the triggering operating situation is defined by an eye of the operator facing the closure element with the viewing direction of said operator within the scope of the permitted orientation range.

In some embodiments, the triggering operating situation includes a logical conjunction, in particular an AND conjunction and/or an OR conjunction of two operating-situation conditions, such that the triggering operating situation includes the logical conjunction of the orientation of the upper body of the operator facing the closure element and the orientation of the head of the operator facing the closure element.

In some embodiments, the sensor assembly comprises one first sensor element which is directed to the detection of a first operating-situation condition of the triggering operating situation, and the sensor assembly comprises at least one second sensor element which is directed to the detection of at least one second operating-situation condition of the triggering operating situation.

In some embodiments, an operating-situation condition of the triggering operating situation is defined by the position of the operator not changing within a predetermined time window, or changing only within a predetermined position range.

In some embodiments, an operating-situation condition of the triggering operating situation is defined by the operator moving out of a predetermined close range, which is assigned to the closure element and/or the motor vehicle, and subsequently moving back into the close range.

An embodiment provides a control system for a motorized closure element assembly of a motor vehicle, in particular for carrying out a method as described herein, comprising a control assembly and a sensor assembly, wherein the measured sensor values of the sensor assembly are monitored by or with the control assembly to determine whether a triggering operating situation, which is defined by at least one operating-situation condition, is present, and wherein the control assembly triggers an activation of the closure element assembly upon detection of the triggering operating situation, wherein an operating-situation condition of the triggering operating situation is defined by the orientation of at least one body part of the operator about the vertical axis lying within a predetermined permitted orientation range, and the sensor assembly detects whether the orientation of the at least one body part of the operator about the vertical axis lies within the permitted orientation range and, depending thereon, triggers the activation of the closure element assembly.

### BRIEF DESCRIPTION OF THE DRAWINGS

Various embodiments are explained in greater detail in the following with reference to only one drawing which illustrates an exemplary embodiment. In the drawing:

FIG. 1 shows a side view of the rear region of a motor vehicle comprising a motorized closure element assembly and comprising a control system according to the disclosure, which is assigned to the closure element, and

FIG. 2 shows a view from above of the rear region of the motor vehicle according to FIG. 1 in three operating situations, a) in which the operator is facing the closure element, and b) in which the operator is facing away from the closure element.

### DETAILED DESCRIPTION

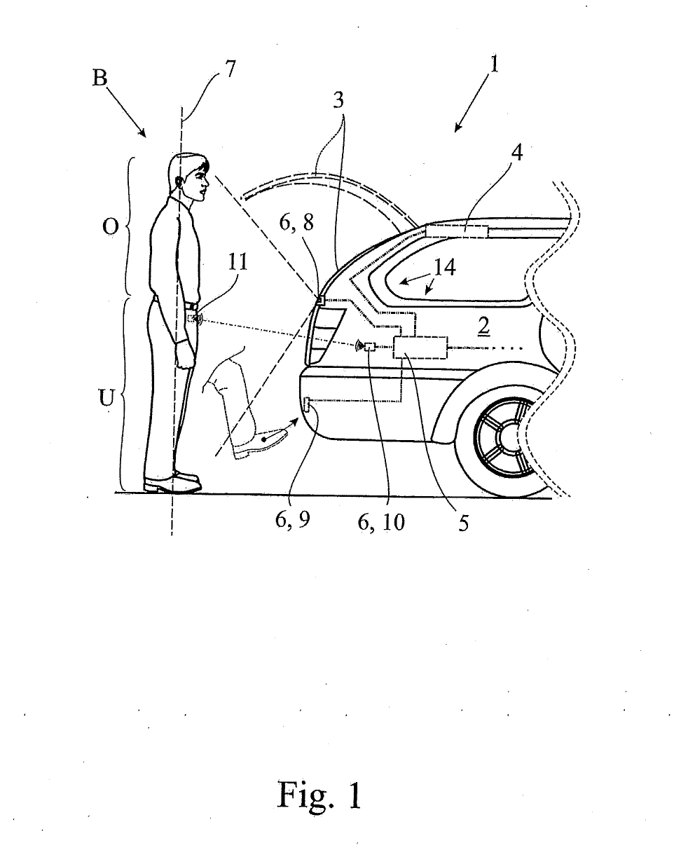

Turning to FIG. 1, a method according to various embodiments can be used for activating a motorized closure element assembly 1 of a motor vehicle 2, which is equipped with a closure element 3, a control assembly 5, and a sensor assembly 6. In this case, the closure element assembly is also equipped with a drive assembly 4, which is assigned to the closure element 3, for the motorized displacement of the closure element 3.

The closure element 3 can be any type of closure element of a motor vehicle, as was described in the introductory part of the description. In this case, the closure element 3 is the tailgate of a motor vehicle 2. All comments made with respect to a tailgate apply similarly for all other types of closure elements.

In an embodiment, the term “activation of the motorized closure element assembly” means that the closure element 3 is displaced by the drive assembly 4 upon activation. The activation of the closure element assembly 1 is therefore always associated with an energization of a non-illustrated drive motor of the drive assembly 4. Specifically, within the scope of an activation, the closure element 3 of the closure element assembly 1 can be entirely or partially displaced between a completely closed position (indicated using a solid line in FIG. 1) and a completely open position (indicated using a dashed line in FIG. 1) by the drive assembly 4. In principle, it can also be provided that an activation of the motorized closure element assembly 1 merely effectuates a pressing upon the closure element 3, and therefore a grip gap forms between the closure element 3 and the motor vehicle body, into which the operator can grip and manually carry out the further displacement of the closure element 3.

In an embodiment, the term “activation of the motorized closure element assembly” means that a motor vehicle locking system, in particular at least one motor vehicle lock associated therewith, which is assigned to the closure element assembly 1 and is not shown here, is displaced by a motor upon activation. The displacement of the motor vehicle lock can be a motorized displacement of the lock state, for example, between the lock states “locked” and “unlocked”, and therefore the motor vehicle lock can be opened, depending on the lock state. It is furthermore conceivable that the displacement of the motor vehicle lock effectuates the opening of the motor vehicle lock, and therefore the associated closure element 3 is released in the opening direction. Finally, the displacement of the motor vehicle lock can be an aforementioned pressing upon the closure element 3 in the aforementioned sense.

In the present case, the term “motorized” includes any displaceability using an actuator of any type, in particular an electrical actuator.

The measured sensor values of the sensor assembly 6 are monitored by the control assembly 5 to determine whether a triggering operating situation is present. The control assembly 5 is therefore coupled to the sensor assembly 6 for control purposes, and therefore the generation of corresponding measured sensor values of the sensor assembly 6 can be triggered by the control assembly 5. The sensor assembly 6 can comprise distance sensors, imaging sensors, or the like, depending on the application. Capacitive sensors have proven effective as distance sensors. In this respect, reference is made to the German application DE 10 2014 101 661 A1, dated Feb. 11, 2014, which belongs to the applicant and which is therefore made the subject matter of the present application and incorporated herein by reference.

The sensor assembly can also include a radar sensor, by which body parts of the operator, including their orientation, can be easily detected.

Finally, the sensor assembly can comprise a camera-based sensor as an imaging sensor. A 3D camera system having at least two camera sensors, which are separated from each other, can be utilized in this case.

The sensor assembly 6 is used, as indicated above, for monitoring the measured sensor values of the sensor assembly 6 to determine whether a triggering operating situation is present. Such an operating situation is defined, according to the disclosure, by at least one operating-situation condition. In principle, such an operating-situation condition can relate to static parameters such as the present position, but also to dynamic parameters such as the movement of at least one body part of the operator. In the detection of an operating situation defined in this way, a corresponding activation of the closure element assembly 1 is carried out by or with the control assembly 5.

When the closure element 3 is completely closed, the detection of an aforementioned triggering operating situation can result in the closure element 3 being displaced by or with the drive assembly 4 in the opening direction, such as in the completely opened position. Conversely, when the closure element 3 is completely open, the detection of a triggering operating situation can result in the closure element 3 being displaced by or with the drive assembly 4 in the closing direction, such as in the completely closed position.

An entirely special definition of an operating situation is essential for the solution according to the disclosure. An operating-situation condition of the triggering operating situation is therefore defined as the orientation of at least one body part O of the operator B about the vertical axis 7 lying in a predetermined permitted orientation range A. In this case, the vertical axis 7 is a geometric, vertically oriented axis about which the relevant body part O of the operator B can possibly also swivel. In this case, the relevant body part O of the operator B can be the upper body O of the operator B. The term “upper body” is considered to mean the trunk of the body of the operator B in this case.

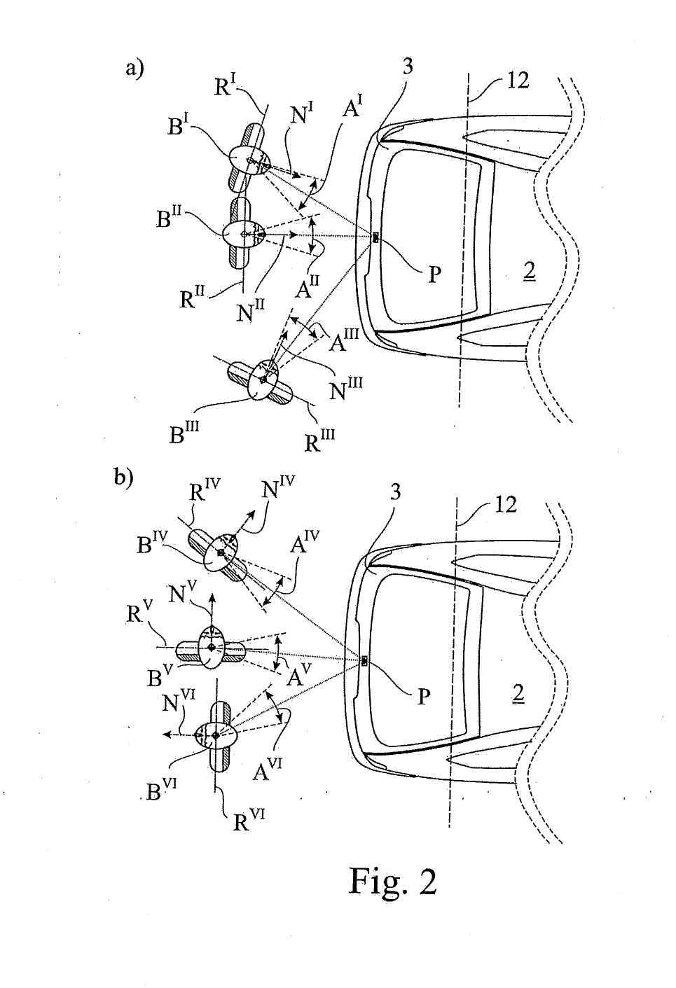

It is furthermore essential to the solution according to the disclosure that whether the orientation of the at least one body part O of the operator B about the vertical axis 7 lies in the permitted orientation range A is detected by or with the sensor assembly 6. The activation of the closure element assembly 1 is carried out depending on whether the orientation of the at least one body part O of the operator B about the vertical axis 7 lies in the permitted orientation range A or not. In one embodiment which will be explained further below, this means that the activation of the closure element assembly 1 is possible, in theory, in the situation shown in FIG. 2a, and is ruled out in the situation shown in FIG. 2b. Considering these two depictions in combination clearly shows that the likelihood of an undesired activation of the closure element assembly 1 can be reduced by the solution according to the disclosure by way of the orientation of at least one body part O of the operator B being incorporated into the triggering operating situation.

As mentioned above, the sensor assembly 6 can be implemented in an entirely different way. In this case, the sensor assembly 6 comprises a camera-based sensor element 8, which can be designed as a type of 3D camera, for detecting the orientation of the operator B. As a result, it is readily possible to ascertain not only the position but also the orientation of the particular body part O of the operator B. In this case, a capacitive distance sensor 9 is additionally provided, which can extend across the width of the motor vehicle 2. An operator gesture, for example, a foot movement indicated in FIG. 1, can be well detected by or with the capacitive distance sensor 9.

Finally, a transceiver unit 10 is provided, which can also be assigned to the sensor assembly 6 in the present case. The transceiver unit 10 is used for communication with a portable identification unit such as an electronic key or an ID card having an integrated RFID chip. With the transceiver unit 10, not only can the operator B be authenticated, but also the distance of the operator B, who is carrying the portable identification unit 11, to the transceiver unit 10 can be determined. In principle, this distance can be defined, in the above-described sense, as an operating-situation condition of the triggering operating situation.

In the determination of the orientation of a body part O of the operator B, a reference plane R lying in the relevant body part O of the operator B can be assigned to the relevant body part O. In this case, it is assumed that each body part O of the operator B has a front side and a back side, with respect to the forward viewing direction of the operator B in each case. The reference plane R is therefore defined in such a way that one side of the reference plane R faces forward and the other side of the reference plane R faces rearward, which is expressed, in each case, by a corresponding orientation of the normal vectors of the surfaces of the reference planes R positioned opposite each other. A reference plane R defined in this way is indicated in the drawing for the upper body O of the operator B. There, the reference plane R extends as described through the relevant body part O and has an orientation which is oriented on the front side or the rear side of the upper body O of the operator B.

One embodiment is particularly significant in this case in which it is important that the front side of at least one body part O of the operator B faces the closure element 3. Specifically, in some embodiments, an operating-situation condition of the triggering operating situation is defined by the front side of at least one body part O, specifically the upper body O of the operator B in this case, facing the closure element 3. This is defined in the present case by the front side of the relevant body part O of the operator B deviating from its orientation with respect to a predetermined reference point P on the closure element 3 only within the permitted orientation range A. This can be achieved by way of the forward pointing normal vector N of the reference plane R of the relevant body part O lying within the permitted orientation range A. The orientation range A is defined in the drawing by way of the orientation range A permitting a permitted angular deviation from the exact orientation of the body part O with respect to the reference point P in both swivel directions about the vertical axis 7. Other definitions of the orientation range A are conceivable. In this case, the orientation range A lies in an angular range between 45° and 135°.

The reference point P is defined in this case in such a way that said reference point essentially lies in the middle region of the closure element 3, along the transverse axis 12 of the motor vehicle 2. In principle, the reference point P can be provided at other points. It is also conceivable that multiple such reference points P are provided.

It has already been pointed out that an operating-situation condition of the triggering operating situation is defined here by the front side of the upper body O of the operator B facing the closure element 3 within the scope of the permitted orientation range A. The detection of the orientation of the upper body O of the operator B is advantageous since the upper body O can be detected using sensors by way of relatively simple means. FIG. 2a shows three situations in which the operator B is labeled with the reference signs B^{I}, B^{II} and B^{III}, respectively. In all three positions, it is shown that the relevant normal vectors N^{I}, N^{II}, and N^{III} lie within the assigned orientation range A^{I}, A^{II} and A^{III}. This means that the upper body O of the operator B faces the closure element 3 in the aforementioned sense, and therefore the activation of the closure element assembly 1 can take place subject to the detection of further operating-situation conditions which are possibly assigned to the operating situation.

A different case is shown in the depiction of three further situations according to FIG. 2b in which the operator B is indicated by the reference signs B^{IV}, B^{V} and B^{VI}, respectively. In this case, it becomes clear that the relevant normal vectors N^{IV}, N^{V} and N^{VI} each lie outside of the assigned orientation range A^{IV}, A^{V} and A^{VI}, respectively. This means that the orientation of the upper body O of the operator B about the vertical axis 7 does not lie within the permitted orientation range A, and therefore an activation of the closure element assembly 1 is not triggered.

The method according to the disclosure can also be applied to other body parts O of the operator B. For example, an operating-situation condition of the triggering operating situation can be defined by the front side of the head of the operator B facing the closure element 3 within the scope of the permitted orientation range A. The same basic principle can also be applied to other body parts O of the operator B, in particular to the lower body U of the operator B and/or to limbs such as the legs of the operator B.

Another body part O of the operator B is, in principle, an eye of the operator B. Within this framework, an operating-situation condition of the triggering operating situation can be defined by an eye of the operator B facing the closure element 3 with the viewing direction of said operator within the scope of the permitted orientation range. For this purpose, the sensor assembly 6 can comprise a sensor element which can detect the viewing direction of the eye of the operator B. A number of approaches have been described in the prior art for this purpose, which can possibly also correspondingly detect both eyes of the operator B.

As indicated above, a triggering operating situation can include multiple operating-situation conditions. Within the scope of the definition of the operating situation, these operating-situation conditions can be logically linked to each other, in particular being AND-linked and/or OR-linked. This can mean, for example, that the triggering operating situation includes the logical conjunction of the orientation of the upper body O of the operator B facing the closure element 3 with the orientation of the head of the operator B facing the closure element 3. The triggering operating situation can also include other operating-situation conditions, however.

In principle, a particularly good reliability of detection results by way of the sensor assembly 6 comprising one first sensor element which is directed to the detection of a first operating-situation condition of the triggering operating situation, and the sensor assembly 6 comprising at least one second sensor element which is directed to the detection of at least one second operating-situation condition of the predetermined situation.

In the embodiment which is depicted, an operating-situation condition relates to a foot movement of the operator B depicted in FIG. 1, which is detected by or with the capacitive distance sensor 9.

One further operating-situation condition relates to the aforementioned orientation of the upper body O of the operator B, which is detected with the camera-based sensor element 8. The activation of the closure element assembly 1, for a motorized displacement of the closure element 3 in the opening direction in this case, is carried out only if both operating-situation conditions have been detected in the sense of an AND-conjunction.

Alternatively or additionally, it can be provided that an operating-situation condition of the triggering operating situation is defined by the position of the operator B not changing within a predetermined time window, or changing only within a predetermined position range. This predetermined position range can be a position range which is located in the direct proximity of the closure element 3.

One further operating-situation condition of the triggering operating situation can be defined by the operator B moving out of a predetermined close range, which is assigned to the closure element 3 and/or the motor vehicle 2, and subsequently moving back into the close range. Other operating-situation conditions which can also be logically linked to each other are conceivable.

According to one further teaching, a control system 14 for a motorized closure element assembly 1 of a motor vehicle 2 is described as a system which is configured especially for carrying out the aforementioned method according to the disclosure. In this respect, reference is made to all comments related to the method according to the disclosure.

The control system 14 according to the disclosure comprises a control assembly 5 and a sensor assembly 6, wherein the measured sensor values of the sensor assembly 6 are monitored by or with the control assembly 5 to determine whether an above-described, triggering operating situation is present, and wherein the control assembly 5 triggers an activation of the closure element assembly 1 upon detection of the triggering operating situation. For the rest, the mode of operation of the control system 14 corresponds to an implementation of the aforementioned method according to the disclosure.

1. A method for activating a motorized closure element assembly of a motor vehicle, wherein the closure element assembly comprises a closure element, a control assembly, and a sensor assembly, the method comprising monitoring measured sensor values of the sensor assembly with the control assembly to determine whether a triggering operating situation, which is defined by at least one operating-situation condition, is present;
wherein an activation of the closure element assembly is triggered by the control assembly upon detection of the triggering operating situation;
wherein an operating-situation condition of the triggering operating situation is defined by the orientation of at least one body part of the operator about the vertical axis lying within a predetermined permitted orientation range; and
wherein the sensor assembly detects whether the orientation of the at least one body part of the operator about the vertical axis lies within the permitted orientation range and, depending thereon, triggers the activation of the closure element assembly.

2. The method according to claim 1, wherein an operating-situation condition of the triggering operating situation is defined by the front side of at least one body part of the operator facing the closure element by way of the front side of the relevant body part of the operator deviating from its orientation with respect to a predetermined reference point on the closure element only within the permitted orientation range.

3. The method according to claim 2, wherein an operating-situation condition of the triggering operating situation is defined by the front side of the upper body of the operator facing the closure element within the scope of the permitted orientation range.

4. The method according to claim 2, wherein an operating-situation condition of the triggering operating situation is defined by the front side of the head of the operator facing the closure element within the scope of the permitted orientation range.

5. The method according to claim 1, wherein an operating-situation condition of the triggering operating situation is defined by an eye of the operator facing the closure element with the viewing direction of said operator within the scope of the permitted orientation range.

6. The method according to claim 1, wherein the triggering operating situation includes a logical conjunction.

7. The method according to claim 1, wherein the sensor assembly comprises one first sensor element which is directed to the detection of a first operating-situation condition of the triggering operating situation, and the sensor assembly comprises at least one second sensor element which is directed to the detection of at least one second operating-situation condition of the triggering operating situation.

8. The method according to claim 1, wherein an operating-situation condition of the triggering operating situation is defined by the position of the operator not changing within a predetermined time window.

9. The method according to claim 1, wherein an operating-situation condition of the triggering operating situation is defined by the operator moving out of a predetermined close range, which is assigned to the closure element and/or the motor vehicle, and subsequently moving back into the close range.

10. A control system for a motorized closure element assembly of a motor vehicle, comprising a control assembly and a sensor assembly, wherein the measured sensor values of the sensor assembly are monitored with the control assembly to determine whether a triggering operating situation, which is defined by at least one operating-situation condition, is present;
wherein the control assembly triggers an activation of the closure element assembly upon detection of the triggering operating situation;
wherein an operating-situation condition of the triggering operating situation is defined by the orientation of at least one body part of the operator about the vertical axis lying within a predetermined permitted orientation range; and
wherein the sensor assembly detects whether the orientation of the at least one body part of the operator about the vertical axis lies within the permitted orientation range and, depending thereon, triggers the activation of the closure element assembly.

11. The method according to claim 6, wherein the logical conjunction includes at least one of an AND conjunction and an OR conjunction of two operating-situation conditions.

12. The method according to claim 6, wherein the triggering operating situation includes the logical conjunction of the orientation of the upper body of the operator facing the closure element and the orientation of the head of the operator facing the closure element.

13. The method according to claim 1, wherein an operating-situation condition of the triggering operating situation is defined by the position of the operator changing only within a predetermined position range.
